(19) United States
(12) Patent Application Publication
(10) Pub. No.: US 2023/0169469 A1
(43) Pub. Date: Jun. 1, 2023

(54) TUTORIAL MANAGEMENT DEVICE, TUTORIAL MANAGEMENT METHOD, AND NON-TRANSIENT COMPUTER-READABLE RECORDING MEDIUM

(71) Applicant: Honda Motor Co., Ltd., Tokyo (JP)

(72) Inventors: Makoto HASEGAWA, Saitama (JP); Sachiko YAMAMOTO, Saitama (JP); Naoto SHIKANO, Saitama (JP); Shinichiro KOBASHI, Saitama (JP); Kanako IKEDA, Tokyo (JP)

(73) Assignee: Honda Motor Co., Ltd., Tokyo (JP)

(21) Appl. No.: 17/981,477

(22) Filed: Nov. 7, 2022

(30) Foreign Application Priority Data
Nov. 30, 2021 (JP) 2021-194500

(51) Int. Cl. G06Q 10/10; G06Q 10/06; G06T 19/00; G09B 9/04

(52) U.S. Cl. CPC G06Q 10/1091; G06Q 10/0639; G06T 19/006; G09B 9/04

(57) ABSTRACT

A tutorial management device manages, for a user of a moving body, attendance of a pre-use tutorial on an operation method of the moving body conducted before use of the moving body. The tutorial management device includes: an exemption range determination part that determines an exemption range for the user who is exempted from attending a part or all of the pre-use tutorial based on a predetermined exemption condition; and a tutorial management part that manages the attendance of the pre-use tutorial by the user based on the exemption range determined by the exemption range determination part. The tutorial management part requires all of the pre-use tutorial to be attended when the user uses the moving body for a first time, and exempts the user from attending the exemption range among the pre-use tutorial when the user has used the moving body in the past.

### CROSS-REFERENCE TO RELATED APPLICATION

This application claims the priority benefit of Japan application serial no. 2021-194500, filed on Nov. 30, 2021. The entirety of the above-mentioned patent application is hereby incorporated by reference herein and made a part of this specification.

### BACKGROUND

### Technical Field

The disclosure relates to a tutorial management device, a tutorial management method, and a non-transient computer-readable recording medium recording a program.

### Related Art

Conventionally, an inverted pendulum type vehicle is known in which a boarding part is provided on a base in which a moving mechanism such as a wheel for moving on the floor surface and a drive device for driving the moving mechanism are assembled, and an occupant boarding the boarding part tilts his or her body with respect to the vertical direction to travel in the tilting direction (see, for example, Patent Literature 1).

### CITATION LIST

### Patent Literature

[Patent Literature 1] Japanese Granted Patent Publication No. 6220763

Since such an inverted pendulum type vehicle is a vehicle having a unique operation method unlike a general vehicle such as a passenger car, when providing a service using such an inverted pendulum type vehicle, the service provider needs to explain the operation method to the user for safe and comfortable use. Therefore, the service provider must secure human resources for explaining the operation method, which is one of the factors that increase the cost for providing the service.

The disclosure has been made in consideration of such circumstances, and provides a tutorial management device, a tutorial management method and a non-transient computer-readable recording medium recording a program capable of reducing the human load required for explaining the operation method to a user in providing a service using a vehicle.

### SUMMARY

The tutorial management device, the tutorial management method, and the non-transient computer-readable recording medium recording the program according to the disclosure adopt the following configurations.

(1): A tutorial management device according to an embodiment of the disclosure is a device that manages, for a user of a moving body, attendance of a pre-use tutorial on an operation method of the moving body conducted before use of the moving body. The tutorial management device includes: an exemption range determination part that determines an exemption range for the user who is exempted from attending a part or all of the pre-use tutorial based on a predetermined exemption condition; and a tutorial management part that manages the attendance of the pre-use tutorial by the user based on the exemption range determined by the exemption range determination part. The tutorial management part requires all of the pre-use tutorial to be attended when the user uses the moving body for a first time, and exempts the user from attending the exemption range among the pre-use tutorial when the user has used the moving body in the past.

(10): A tutorial management method according to an embodiment of the disclosure is a method that manages, for a user of a moving body, attendance of a pre-use tutorial on an operation method of the moving body conducted before use of the moving body, in which a computer performs: determining an exemption range for the user who is exempted from attending a part or all of the pre-use tutorial based on a predetermined exemption condition; and performing a tutorial management process that manages the attendance of the pre-use tutorial by the user based on the determined exemption range, and in the tutorial management process, requiring all of the pre-use tutorial to be attended when the user uses the moving body for a first time, and exempting the user from attending the exemption range among the pre-use tutorial when the user has used the moving body in the past.

(11): A non-transient computer-readable recording medium recording a program according to an embodiment of the disclosure records a program that manages, for a user of a moving body, attendance of a pre-use tutorial on an operation method of the moving body conducted before use of the moving body, the program causing a computer to perform: determining an exemption range for the user who is exempted from attending a part or all of the pre-use tutorial based on a predetermined exemption condition; and performing a tutorial management process that manages the attendance of the pre-use tutorial by the user based on the determined exemption range, and in the tutorial management process, requiring all of the pre-use tutorial to be attended when the user uses the moving body for a first time, and exempting the user from attending the exemption range among the pre-use tutorial when the user has used the moving body in the past.

### BRIEF DESCRIPTION OF THE DRAWINGS

FIG. 1 is a first diagram showing an outline of the appearance of an inverted pendulum type vehicle according to a vehicle rental service of this embodiment.

FIG. 2 is a second diagram showing an outline of the appearance of an inverted pendulum type vehicle according to a vehicle rental service of this embodiment.

FIG. 3 is a diagram showing an outline of the configuration of the omnidirectional moving wheel.

FIG. 4 is a first diagram showing an operation example of the inverted pendulum type vehicle.

FIG. 5 is a second diagram showing an operation example of the inverted pendulum type vehicle.

FIG. 6 is a diagram showing a flow of renting the inverted pendulum type vehicle to the user U after conducting the pre-use tutorial in a vehicle rental service.

FIG. 7 is a diagram showing a configuration example of the vehicle rental system of this embodiment.

FIG. 8 is a diagram showing an example of a functional configuration of an inverted pendulum type vehicle according to this embodiment.

FIG. 9 is a diagram showing an example of a functional configuration of the management device according to this embodiment.

FIG. 10 is a diagram showing an example of a functional configuration of the testing device according to this embodiment.

FIG. 11 is a flowchart showing an example of a flow of a process in which the vehicle rental system carries out a pre-use tutorial of the inverted pendulum type vehicle.

FIG. 12 is a flowchart showing an example of a flow of the tutorial exemption process carried out by the management device.

FIG. 13 is a diagram showing that in the vehicle rental system of this embodiment, the pre-use tutorial is exempted within the range according to the experience of the user regarding the operation of the inverted pendulum type vehicle.

### DESCRIPTION OF THE EMBODIMENTS

(2): In the above aspect (1), the tutorial management device further includes a browsing information management part that enables the user to browse browsing information related to the pre-use tutorial before attending the pre-use tutorial. The exemption condition is that the user has browsed the browsing information before attending the pre-use tutorial, and the tutorial management part exempts the attendance of the pre-use tutorial for an exemption time according to a type of the browsing information browsed by the user.

(3): In the above aspect (2), the tutorial management part exempts the attendance of the pre-use tutorial by a first exemption time when a type of the browsing information browsed by the user is text data, exempts the attendance of the pre-use tutorial by a second exemption time when the type of the browsing information browsed by the user is video data, and exempts the attendance of the pre-use tutorial by a third exemption time when the type of the browsing information browsed by the user is VR data.

(4): In the above aspect (3), the exemption condition is that a score calculated based on a usage history of the moving body and indicating a level of a skill for the user to operate the moving body is greater than or equal to a predetermined threshold value, and the tutorial management part exempts the attendance of the pre-use tutorial by a fourth exemption time when the exemption condition is satisfied.

(5): In the above aspect (4), the score is calculated based on information of at least one of speed, acceleration, and angular velocity when the moving body moves at a predetermined place by an operation of the user.

(6): In the above aspect (4) or (5), the exemption condition is that a result of an operation test related to an operation skill of the moving body which the user has taken before using the moving body is at a predetermined level or above, and the tutorial management part exempts the attendance of the pre-use tutorial by a fifth exemption time when the exemption condition is satisfied.

(7): In the above aspect (6), the operation test includes at least one of a first test to evaluate a skill of accelerating and decelerating while moving the moving body straight, a second test to evaluate a skill of turning and moving the moving body, and a third test to evaluate a skill of stopping the moving body.

(8): In the above aspect (6) or (7), the first to fifth exemption times become longer in the order of the first exemption time, the second exemption time, the third exemption time, the fourth exemption time, and the fifth exemption time.

(9) In any of the above aspects (1) to (8), for the moving body, different decorations are determined according to the exemption time of the user.

According to the above aspects (1) to (11), it is possible to reduce the human load required for explaining the operation method to the user in providing the service using the vehicle.

Hereinafter, embodiments of a tutorial management device, a tutorial management method and a program of the disclosure will be described with reference to the drawings.

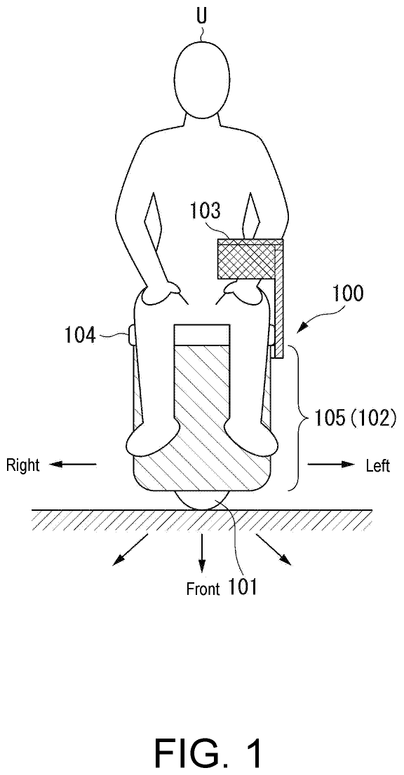

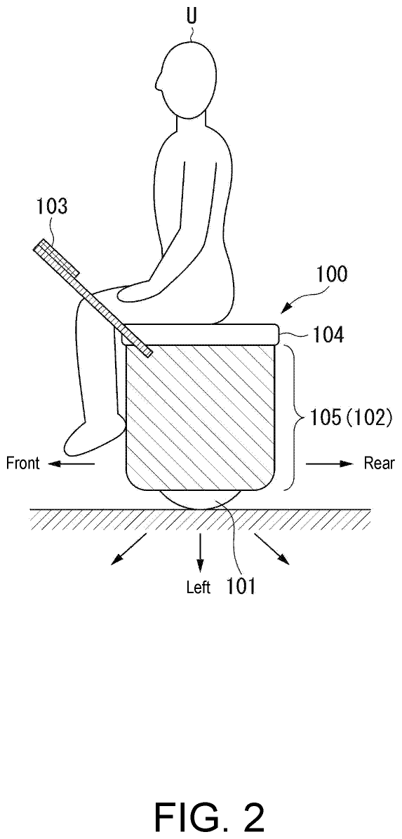

FIG. 1 and FIG. 2 are diagrams showing an outline of the appearance of an inverted pendulum type vehicle 100 according to a vehicle rental service of this embodiment. The vehicle rental service is a service for renting an inverted pendulum type vehicle 100 owned by a service provider to a user. FIG. 1 shows the appearance seen from the front direction, and FIG. 2 shows the appearance seen from the side direction. The inverted pendulum type vehicle 100 is a vehicle in which a boarding part is provided on a base in which a moving mechanism for moving on the floor surface and a drive device for driving the moving mechanism are assembled, and it is a vehicle configured to change the traveling direction in the tilting direction when a user U (occupant) who has boarded the boarding part tilts his or her body with respect to the vertical direction.

The inverted pendulum type vehicle 100 includes, for example, an omnidirectional moving wheel 101 as a moving mechanism, a drive device 102 for driving the omnidirectional moving wheel 101, an operation panel 103, a boarding part 104, and a base 105 for integrally assembling them. The omnidirectional moving wheel 101 is a wheel that enables the vehicle to immediately advance in any direction (all directions of 360 degrees) from the current position (omnidirectional movement) without performing a preliminary operation such as turning.

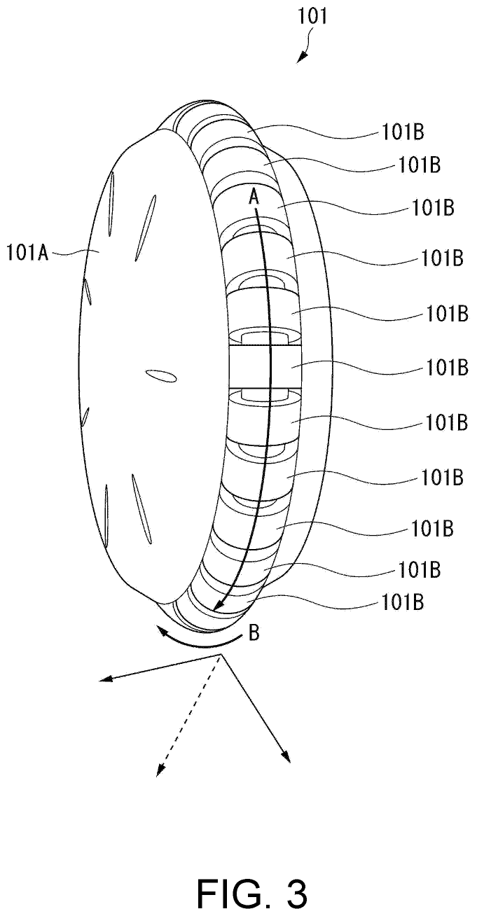

FIG. 3 is a diagram showing an outline of the configuration of the omnidirectional moving wheel 101. The omnidirectional moving wheel 101 includes, for example, a large diameter wheel 101A and multiple small diameter wheels 101B arranged along the circumference of the large diameter wheel 101A. The large diameter wheel 101A is a wheel that mainly realizes straight-ahead movement in the front-rear direction. The small diameter wheel 101B is a wheel that mainly realizes lateral movement on the spot by rotating in the direction of arrow B about the rotation direction (circumferential direction; arrow A) of the large diameter wheel 101A. The omnidirectional moving wheel 101 is driven by a motor (not shown) that may independently control the rotation of the large diameter wheel 101A and the small diameter wheels 101B. With such a configuration, the omnidirectional moving wheel 101 may move forward/backward, left/right, and diagonally in any direction from the spot.

The inverted pendulum type vehicle 100 may be provided with a turning wheel in addition to the omnidirectional moving wheel 101. For example, the turning wheel may be disposed as a rear wheel of the omnidirectional moving wheel 101, and the direction of the inverted pendulum type vehicle 100 may be changed by rotating on a rotation axis orthogonal to the rotation axis of the large diameter wheel 101A. That is, when only the turning wheel is rotated, the inverted pendulum type vehicle 100 is rotated on the spot, and when the large diameter wheel 101A and the turning wheel are rotated at the same time, the inverted pendulum type vehicle 100 may be turned forward while changing its direction in the traveling direction.

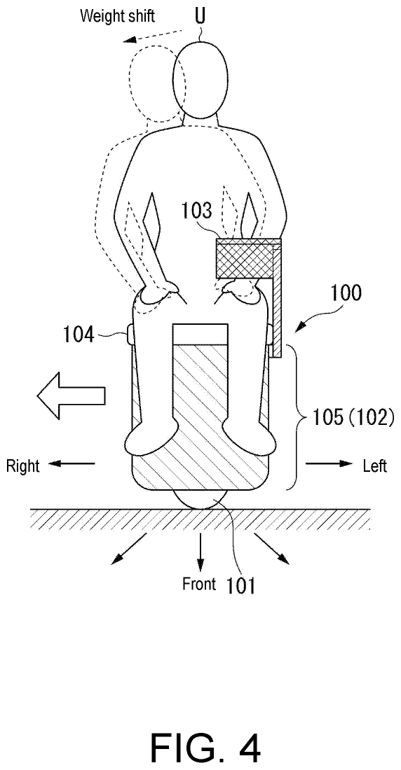

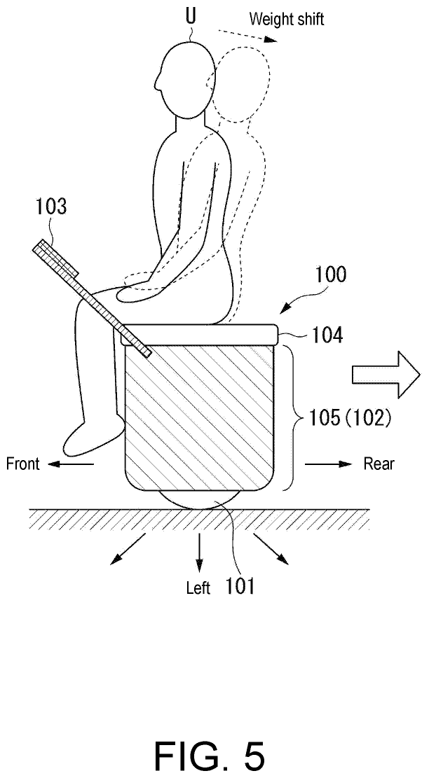

FIG. 4 and FIG. 5 are diagrams showing an operation example of the inverted pendulum type vehicle 100. The inverted pendulum type vehicle 100 is equipped with an IMU sensor for detecting the balance state of the own vehicle, and the inverted pendulum type vehicle 100 is configured to balance the own vehicle based on the detection result of the IMU sensor. FIG. 4 shows a case where the user U shifts his or her weight in the right direction with the front direction of the paper as the front direction with respect to the inverted pendulum type vehicle 100 configured as described above. In this case, the inverted pendulum type vehicle 100 moves to the right in order to restore the balance lost due to the weight shift of the user U. Further, FIG. 5 shows a case where the user U shifts his or her weight in the rear direction (to the right of the paper), and in this case, the inverted pendulum type vehicle 100 moves in the rear direction in order to restore the balance. By performing such balance control, the user U may instruct the moving direction to the inverted pendulum type vehicle 100 by shifting the weight in the direction in which he or she wants to travel. Further, when the user U makes a large weight shift, the inverted pendulum type vehicle 100 is controlled to move faster in order to restore the balance. As a result, the user U may adjust the moving speed of the inverted pendulum type vehicle 100 by changing the magnitude of the weight shift of the user U.

However, since the operation method by weight shift is different from the general operation method by operating a steering wheel and pedals, it is dangerous for a person who is not skilled in such an operation method to operate the inverted pendulum type vehicle 100 without preparation. Therefore, when such an inverted pendulum type vehicle 100 is used for a service, before renting out the inverted pendulum type vehicle 100, the service provider needs to explain the operation method to the user in advance, such as by giving a tutorial, so that the user acquires a certain degree of operation skills. Hereinafter, such a pre-training is referred to as a “pre-use tutorial.”

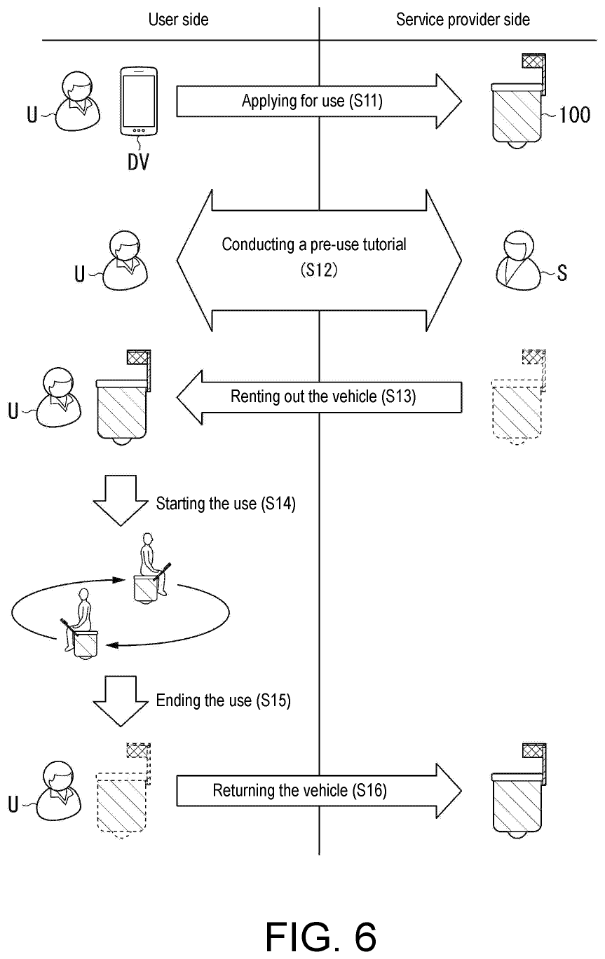

FIG. 6 is a diagram showing a flow of renting the inverted pendulum type vehicle 100 to the user U after conducting the pre-use tutorial in a vehicle rental service. First, the user U accesses the service provider's system using a terminal device DV (hereinafter referred to as “user terminal”) such as a smart phone or a tablet, and applies for the use of the inverted pendulum type vehicle 100 (step S11). When the service provider receives the application for use in step S11, the service provider conducts a pre-use tutorial for the user U (step S12). For example, in the pre-use tutorial, an instructor S of the service provider may teach the user U the operation method, or the user U may learn the operation method by playing the tutorial content provided by the service provider on the user terminal DV.

When the service provider confirms that the user U has completed the pre-use tutorial, the service provider rents the inverted pendulum type vehicle 100 to the user U (step S13). The user U starts using the rented inverted pendulum type vehicle 100 (step S14), and when the use ends (step S15), returns the rented inverted pendulum type vehicle 100 to the service provider (step S16).

However, in the flow of the vehicle rental service shown in FIG. 6, it is troublesome for both the user and the service provider to have all the users receive the same pre-use tutorial every time. Therefore, in the vehicle rental system 1 of the embodiment, the inverted pendulum type vehicle 100, a management device 200, and a testing device 300 are provided with the configurations described below, so that a part or all of the pre-use tutorial may be skipped depending on the user's experience. Hereinafter, the configurations of the inverted pendulum type vehicle 100, the management device 200, and the testing device 300 that realize such a function in the vehicle rental system 1 will be described in detail.

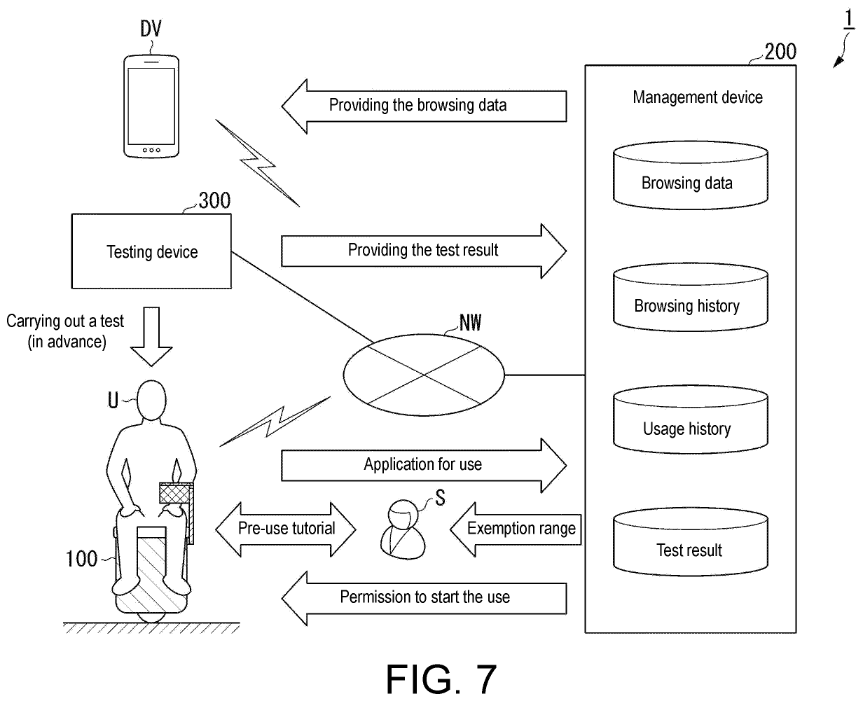

FIG. 7 is a diagram showing a configuration example of the vehicle rental system 1 of this embodiment. The vehicle rental system 1 is a system that supports the provision of a vehicle rental service by the service provider. The vehicle rental service is an example of “service using a vehicle.” The vehicle rental system 1 includes, for example, an inverted pendulum type vehicle 100, a management device 200, and a testing device 300. The inverted pendulum type vehicle 100, the management device 200, and the testing device 300 may communicate with each other via a network NW, and may communicate with the user terminal DV via the network NW. The network NW may be a local area network (LAN) or may include a wide area network (WAN).

The management device 200 is a device that manages, provides, collects and stores various information related to the pre-use tutorial, and the like. For example, the management device 200 has a function of providing browsing data to an external device such as the user terminal DV. The browsing data is data such as text data, video data, and virtual reality (VR) data created for explaining the operation method of the inverted pendulum type vehicle 100. The browsing data is managed so that the user U may browse it prior to attending the pre-use tutorial. The management device 200 provides browsing data in response to a request of the user U, and records the browsing history of the browsing data by the user U.

Further, the management device 200 has a function of managing the tutorial time of the pre-use tutorial for the user U of the vehicle rental service. Specifically, when the management device 200 receives an application for use of the inverted pendulum type vehicle 100 from the user U, the management device 200 determines the range of pre-use tutorial that may be exempted for the user U (hereinafter referred to as the “exemption range”). For example, the management device 200 determines the exemption range based on the browsing history, usage history, test result, and the like of the user U, and notifies the instructor S. Here, the usage history is the history of the use of the inverted pendulum type vehicle 100 by the user U, and the test result is the result of a skill test (hereinafter referred to as the “operation test”) related to the operation of the inverted pendulum type vehicle 100. The instructor S conducts the pre-use tutorial for the user U in a form that may skip the tutorial of the exemption range, and when the user U completes the pre-use tutorial, the user U is permitted to start using the inverted pendulum type vehicle 100. The permission to start the use may be to rent the inverted pendulum type vehicle 100 to the user U, or to change the state of the inverted pendulum type vehicle 100 to a state in which the user U may use it. For example, the instructor S may execute the permission to start the use, or the management device 200 may execute the permission in response to the operation of the instructor S.

The testing device 300 carries out an operation test for the user U of the vehicle rental service, and provides the result of the carried out operation test to the management device 200. Specifically, the testing device 300 acquires state information indicating the state of the inverted pendulum type vehicle 100 during the test from the inverted pendulum type vehicle 100, and evaluates the operation skill of the user U based on the acquired state information. For example, the state information includes information such as the speed, acceleration, and angular velocity of the inverted pendulum type vehicle 100.

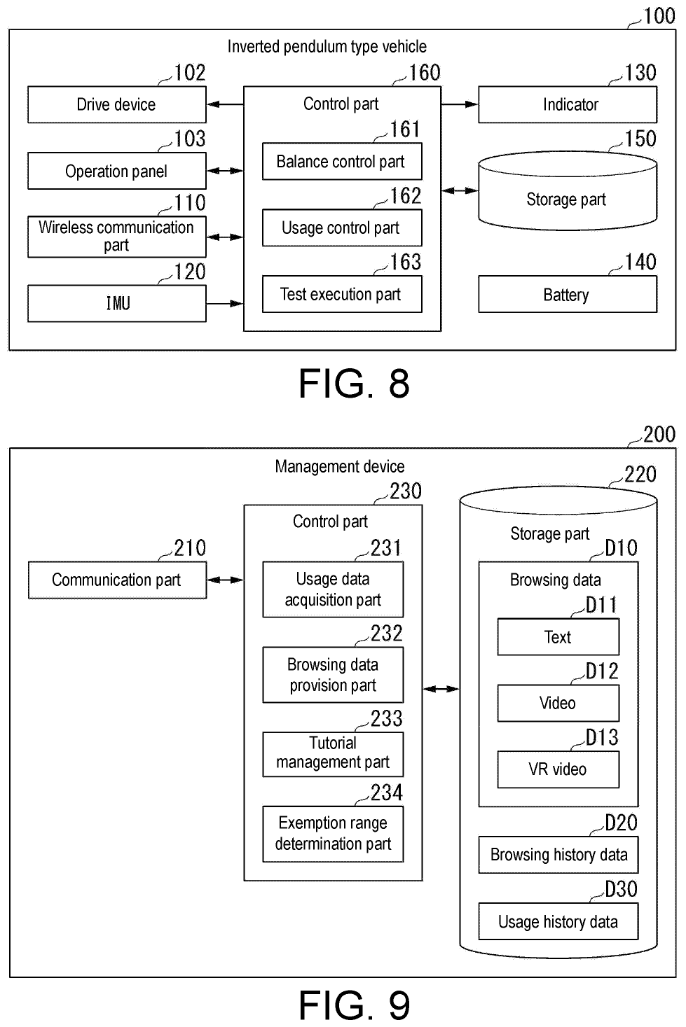

FIG. 8 is a diagram showing an example of a functional configuration of the inverted pendulum type vehicle 100 according to this embodiment. The inverted pendulum type vehicle 100 includes, for example, a drive device 102, an operation panel 103, a wireless communication part 110, an IMU 120, an indicator 130, a battery 140, a storage part 150, and a control part 160. The inverted pendulum type vehicle 100 is realized by, for example, a hardware processor such as a central processing unit (CPU) executing a program (software). In addition, some or all of these components may be realized by hardware (a circuit part, including circuitry) such as a large scale integration (LSI), an application specific integrated circuit (ASIC), a field-programmable gate array (FPGA), a graphics processing unit (GPU) and the like, or may be realized by the cooperation of software and hardware. The program may be stored in advance in a storage device such as the storage part 150 (a storage device including a non-transient storage medium), or may be stored in a removable storage medium such as a DVD or a CD-ROM, and may be installed in the storage part 150 of the inverted pendulum type vehicle 100 or the like by attaching the storage medium (non-transient storage medium) to the drive device.

The drive device 102 and the operation panel 103 are as described above. The drive device 102 drives the omnidirectional moving wheel 101 under the control of the control part 160. The operation panel 103 receives an input operation for the inverted pendulum type vehicle 100 and outputs it to the control part 160, and also outputs information such as image and sound output by the control part 160.

The wireless communication part 110 is a communication interface for connecting the inverted pendulum type vehicle 100 to the network NW. The wireless communication part 110 communicates with the management device 200 and the testing device 300 via the network NW. The wireless communication part 110 may be a wireless local area network (LAN) interface based on Wi-Fi (registered trademark), Bluetooth (registered trademark), or the like, or may be a wide area network (WAN) interface connected to a cellular network, a dedicated line, or the like.

The inertial measurement unit (IMU) 120 is a sensor that detects a three-dimensional inertial motion. The IMU 120 includes an acceleration sensor that detects translational motion, a gyro sensor that detects rotational motion, and the like.

The indicator 130 is a device such as a sign, a meter, a display, a pointer, an index, and the like, and is a device for indicating decorations related to the state of the inverted pendulum type vehicle 100 and the user U.

The battery 140 functions as a power supply for supplying power to each part of the inverted pendulum type vehicle 100. As the battery 140, for example, a rechargeable storage battery such as a lithium ion battery, a nickel hydrogen battery, or a nickel cadmium battery is used. The battery 140 may be fixed to the inverted pendulum type vehicle 100 or may be detachable from the inverted pendulum type vehicle 100.

The storage part 150 is a storage device such as a hard disk drive (HDD), a solid state drive (SSD), a flash memory, or the like. The storage part 150 stores various information related to the control of the inverted pendulum type vehicle 100.

The control part 160 controls the operation of the inverted pendulum type vehicle 100. The control part 160 includes, for example, a balance control part 161, a usage control part 162, and a test execution part 163. The balance control part 161 controls the moving direction and the moving speed of the inverted pendulum type vehicle 100 as described with reference to FIGS. 4 and 5 by the balance control based on the detection result of the IMU 120. By this control, the user U may adjust the moving direction and the moving speed of the inverted pendulum type vehicle 100 by weight shift.

The usage control part 162 controls the use of the inverted pendulum type vehicle 100 by the user U. Specifically, the usage control part 162 permits the user U to start using the inverted pendulum type vehicle 100 when it is confirmed that the user U has attended the pre-use tutorial when using the inverted pendulum type vehicle 100. For example, the usage control part 162 receives an operation of the instructor S and a notification from the management device 200, and changes the own vehicle to the usable state.

Further, the usage control part 162 provides usage data related to the usage of each user U who has used the inverted pendulum type vehicle 100 to the management device 200. For example, the usage data includes identification information of the user U, information on the date and time when the user U started using the inverted pendulum type vehicle 100, information on the date and time when the user U finished using the inverted pendulum type vehicle 100, and the like.

The test execution part 163 cooperates with a test execution part 331 of the testing device 300 to carry out an operation test for the user U. Specifically, the test execution part 163 prompts the user U to perform the operation of the content specified by the testing device 300, and also provides state information indicating the state of the inverted pendulum type vehicle 100 generated by the operation of the user U to the testing device 300.

FIG. 9 is a diagram showing an example of a functional configuration of the management device 200 according to this embodiment. The management device 200 includes, for example, a communication part 210, a storage part 220, and a control part 230. The management device 200 is realized by, for example, a hardware processor such as a CPU executing a program (software). In addition, some or all of these components may be realized by hardware (a circuit part, including circuitry) such as a LSI, an ASIC, a FPGA, a GPU and the like, or may be realized by the cooperation of software and hardware. The program may be stored in advance in a storage device such as the storage part 150 (a storage device including a non-transient storage medium), or may be stored in a removable storage medium such as a DVD or a CD-ROM, and may be installed in the storage part 220 of the management device 200 or the like by attaching the storage medium (non-transient storage medium) to the drive device.

The communication part 210 is a communication interface for connecting the management device 200 to the network NW. The communication part 210 communicates with the inverted pendulum type vehicle 100 and the testing device 300 via the network NW.

The storage part 220 is a storage device such as a HDD, a SSD, a flash memory, or the like. The storage part 220 stores various information related to the operation of the management device 200. For example, the storage part 220 stores browsing data D10 that may be browsed by the user U prior to attending the pre-use tutorial, browsing history data D20 that indicates browsing history of browsing data by the user U, usage history data D30 that indicates the usage history of the inverted pendulum type vehicle 100 by the user U, and the like.

The control part 230 performs a process for exempting a part or all of the pre-use tutorial (hereinafter referred to as “tutorial exemption process”) for the user U of the inverted pendulum type vehicle 100 according to the experience of operation. The control part 230 includes, for example, a usage data acquisition part 231, a browsing data provision part 232, and an exemption range determination part 234.

The usage data acquisition part 231 acquires usage data of each user U from the inverted pendulum type vehicle 100. The usage data acquisition part 231 stores the usage data acquired for each user U in the storage part 220 as usage history data.

The browsing data provision part 232 receives the browsing request of the user U, provides the requested browsing data to the user U, and records the browsing history in the browsing history data D20. For example, when the user U requests browsing of text-format browsing data using the user terminal DV, the browsing data provision part 232 acquires the text-format browsing data D11 from the storage part 220, provides it to the user terminal DV, and records the browsing history in the browsing history data D20. For example, the browsing history includes information on the time when the browsing request is received and information indicating the type of browsing data requested by the user U.

A tutorial management part 233 manages the tutorial range of the pre-use tutorial for the user U based on the exemption range determined by the exemption range determination part 234 in the tutorial exemption process. More specifically, the tutorial management part 233 requires that the user U attend all of the pre-use tutorial when the user U uses the inverted pendulum type vehicle 100 for the first time, and when the user U has used the inverted pendulum type vehicle 100 in the past, the tutorial management part 233 exempts the user U from attending a part or all of the pre-use tutorial when exemption conditions (to be described later) are satisfied.

The exemption range determination part 234 determines the exemption range of the pre-use tutorial for the user U based on the test data, the browsing history data, and the usage history data of the user U. The exemption range may be determined so that the tutorial time of the user U in the pre-use tutorial is shortened by skipping the tutorial of the range. For example, the exemption range may be determined in units of content included in the pre-use tutorial, or may be determined as a skippable time with respect to the total tutorial time of the pre-use tutorial. The exemption range determination part 234 notifies the user U, the instructor S who conducts the pre-use tutorial, and the like of the exemption range determined for the user U.

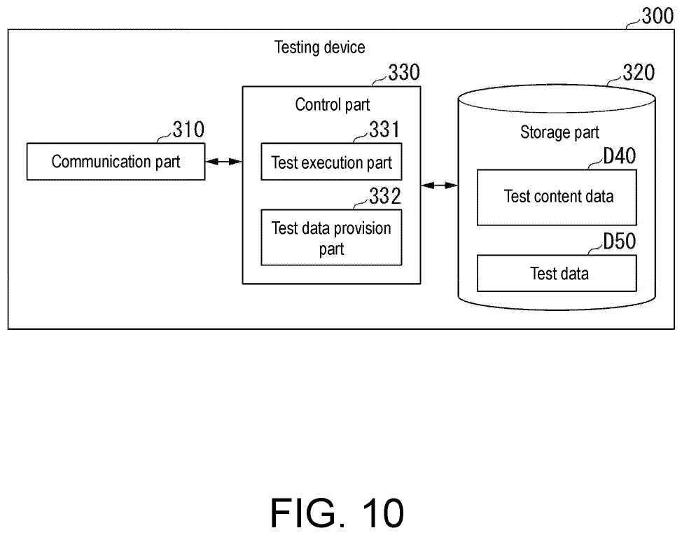

FIG. 10 is a diagram showing an example of a functional configuration of the testing device 300 according to this embodiment. The testing device 300 includes, for example, a communication part 310, a storage part 320, and a control part 330. The testing device 300 is realized by, for example, a hardware processor such as a CPU executing a program (software). In addition, some or all of these components may be realized by hardware (a circuit part, including circuitry) such as a LSI, an ASIC, a FPGA, a GPU and the like, or may be realized by the cooperation of software and hardware. The program may be stored in advance in a storage device such as the storage part 150 (a storage device including a non-transient storage medium), or may be stored in a removable storage medium such as a DVD or a CD-ROM, and may be installed in the storage part 320 of the testing device 300 or the like by attaching the storage medium (non-transient storage medium) to the drive device.

The communication part 310 is a communication interface for connecting the testing device 300 to the network NW. The communication part 310 communicates with the inverted pendulum type vehicle 100 and the management device 200 via the network NW.

The storage part 320 is a storage device such as a HDD, a SSD, a flash memory, or the like. The storage part 320 stores various information related to the operation of the testing device 300. For example, the storage part 320 stores data D40 of the content used for the operation test (hereinafter referred to as “test content”), test data D50 indicating the result of the operation test carried out for the user U, and the like.

The control part 330 cooperates with the inverted pendulum type vehicle 100 to carry out an operation test for the user U of the inverted pendulum type vehicle 100. Specifically, the control part 330 includes a test execution part 331 and a test data provision part 332.

The test execution part 331 cooperates with the test execution part 163 of the inverted pendulum type vehicle 100 to carry out an operation test for the user U of the inverted pendulum type vehicle 100. Specifically, the test execution part 331 instructs the user U of the inverted pendulum type vehicle 100 to operate the predetermined content, and acquires the state information acquired regarding the operation from the inverted pendulum type vehicle 100. The test execution part 331 evaluates the operation skill of the user U based on the content of the operation instructed to the user U and the acquired state information, and determines the test result based on the evaluation result. The test execution part 331 stores information indicating the result of the operation test carried out for the user U in the storage part 320 as test data.

The test data provision part 332 provides the management device 200 with the test data of the user U stored in the storage part 320 in response to a request from the management device 200. The test data provision part 332 may provide all the test data accumulated for the user U to the management device 200, or may provide the latest test data to the management device 200.

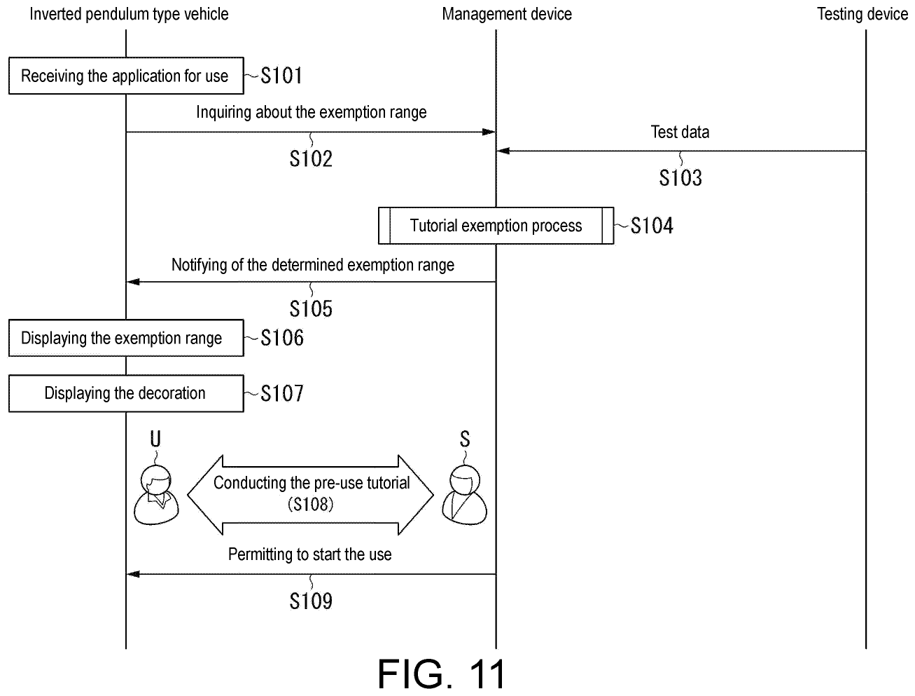

FIG. 11 is a sequence chart showing an example of a flow of a process in which the vehicle rental system 1 carries out a pre-use tutorial of the inverted pendulum type vehicle 100. First, in the inverted pendulum type vehicle 100, the usage control part 162 accepts the application for use of the own vehicle from the user U via the operation panel 103 (step S101). Subsequently, the usage control part 162 inquires of the management device 200 about the exemption range of the pre-use tutorial to be attended by the user U (step S102). Here, it is assumed that the application for use is received in the inverted pendulum type vehicle 100, but as described above, the application for use may be made via the user terminal DV.

Subsequently, in the management device 200, the exemption range determination part 234 receives the inquiry in step S102 and acquires the test data of the user U from the testing device 300 (step S103). The exemption range determination part 234 executes a tutorial exemption process for determining the exemption range according to the experience of the user U based on the test data, the browsing history data, and the usage history data of the user U (step S104). The exemption range determination part 234 notifies the inverted pendulum type vehicle 100 of the determined exemption range (step S105).

In addition, in the inverted pendulum type vehicle 100, the usage control part 162 receives the notification of the exemption range from the management device 200, displays the notified exemption range on the operation panel 103 (step S106), and causes the indicator 130 to display the decoration according to the exemption range (step S107). In this way, by displaying the information indicating the exemption range on the inverted pendulum type vehicle 100, the instructor S may easily visually recognize how much pre-use tutorial should be given to which user U. The instructor S conducts the pre-use tutorial for the user U in a manner that may skip the tutorial of the exemption range (step S108), and permits the user U to start using the inverted pendulum type vehicle 100 when he or she completes the pre-use tutorial (step S109).

For example, when the instructor S recognizes that the user U has completed the pre-use tutorial, the instructor S inputs an operation for permitting to start using the inverted pendulum type vehicle 100 via the operation panel 103. This operation is notified to the usage control part 162. Upon receiving the notification that the pre-use tutorial has been completed, the usage control part 162 instructs the balance control part 161 to make the own vehicle usable. The balance control part 161 receives this instruction and changes the own vehicle into a state in which it may travel. When the inverted pendulum type vehicle 100 performs such a process, for example, the user U may start using the inverted pendulum type vehicle 100.

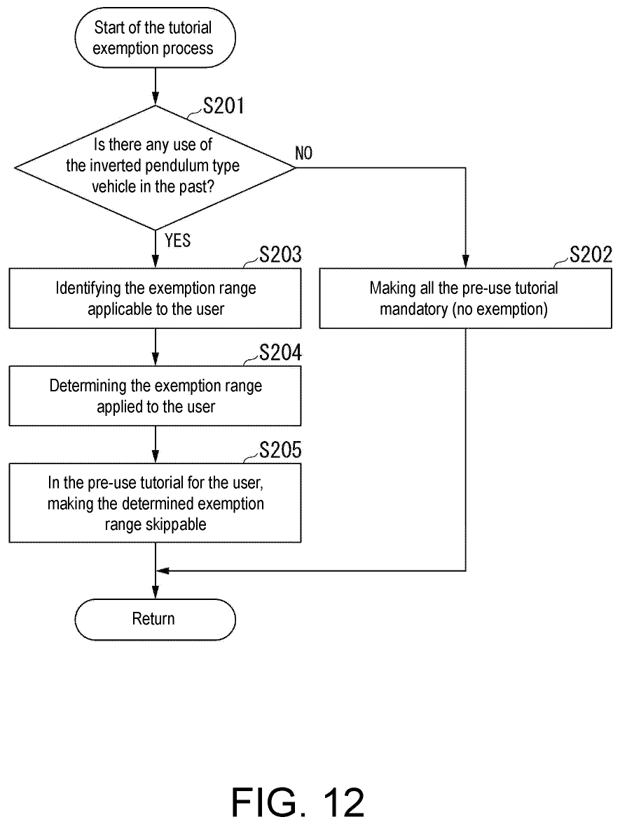

FIG. 12 is a flowchart showing an example of a flow of the tutorial exemption process carried out by the management device 200. First, the tutorial management part 233 refers to the usage history data of the user U, and determines whether the user U has used the inverted pendulum type vehicle 100 in the past (step S201). Here, when it is determined that the user U has never used the inverted pendulum type vehicle 100 in the past, that is, if this use is the first time, the tutorial management part 233 manages the tutorial range for user U by requiring all the pre-use tutorial to be attended (step S202).

In addition, in step S201, when it is determined that the user U has used the inverted pendulum type vehicle 100 in the past, that is, the use this time is the second time or subsequent times, the exemption range determination part 234 identifies the exemption range applicable to the user U from the predetermined exemption range (step S203). Specifically, each exemption range has predetermined conditions for applying the exemption from tutorial in the exemption range (hereinafter referred to as “exemption conditions”), and the exemption range determination part 234 determines the range corresponding to the exemption conditions satisfied for the user U as the exemption range for the pre-use tutorial of the user U (step S204). The tutorial management part 233 manages the tutorial range of the user U so that the tutorial of the exemption range determined by the exemption range determination part 234 becomes skippable in the pre-use tutorial (step S205).

Here, when multiple exemption conditions are satisfied for the user U, that is, when there are multiple exemption ranges applicable to the user U, the exemption range determination part 234 may determine the final exemption range based on the multiple exemption ranges. For example, the exemption range determination part 234 may determine the maximum exemption range among the multiple exemption ranges as the final exemption range, or may determine a range including the multiple exemption ranges as the final exemption range.

In the following, first to third exemption conditions will be illustrated as specific examples of the exemption conditions for applying the exemption range to the attendance of the pre-use tutorial of the user U.

The first exemption condition is that the user U has browsed any of the browsing data before attending the pre-use tutorial. In this case, when the exemption range determination part 234 accesses the browsing history data, refers to the browsing history of the browsing data of the user U, and recognizes that the user U has already browsed some of the browsing data, it determines that the first exemption condition is satisfied. Then, when the first exemption condition is satisfied, the exemption range determination part 234 determines a predetermined range preset for the first exemption condition as the exemption range of the user U.

Further, the exemption range determination part 234 determines the exemption range of the user U according to the type of browsing data browsed by the user U. Here, the description will be made based on the assumption that the types of browsing data include, for example, the three types of “text,” “video,” and “VR,” and that a “first range,” a “second range,” and a “third range” are set as exemption ranges for each type. For example, the browsing data of the type “text” is a teaching material such as a textbook or a manual, and is a teaching material for the user U to learn the operation method by reading. Further, for example, the browsing data of the type “video” is a type of teaching material in which the user U learns the operation method by viewing the video. Further, for example, the browsing data of the type “VR” is a type of teaching material in which the user U learns the operation method by experiencing in a VR space.

As described above, the operation method of the inverted pendulum type vehicle 100 is unique unlike a general vehicle. Therefore, in learning the operation method, it is considered that a learning method having a greater degree of appeal to the senses of the user U may achieve a higher learning effect. Then, it is natural that the user U who has learned by the learning method having a high learning effect is given a larger exemption range. For example, in the above example, the learning effect is considered to be higher in the order of “VR”>“video”>“text,” so the exemption range may be set to increase in the order of the “third range”>the “second range” >the “first range.”

The second exemption condition is that the operation skill of the user U evaluated based on the usage history of the inverted pendulum type vehicle 100 is at a predetermined level or above. For example, in this case, when the exemption range determination part 234 accesses the usage history data, refers to the usage history of the user U, evaluates the content of the operation performed by the user U in the past use, and calculates a score indicating the level of the operation skill, and the score is greater than or equal to a threshold value, it determines that the second exemption condition is satisfied.

Then, when the second exemption condition is satisfied, the exemption range determination part 234 determines a fourth range preset for the second exemption condition as the exemption range of the user U. When there are multiple threshold values, the fourth range may be provided for each threshold value. In general, it is natural that the higher the score, the larger the exemption range is given. In this case, the exemption range determination part 234 may determine the fourth range corresponding to the threshold value having the largest value among the threshold values smaller than the score of the user U as the exemption range of the user U.

Further, in calculating the score, the exemption range determination part 234 quantifies the level of the operation skill of the user U based on the traveling state of the inverted pendulum type vehicle 100 at a predetermined place. The predetermined place may be a place suitable for evaluation of operation skill, and may be, for example, a place near stairs, a narrow place, a crowded place, or the like. The exemption range determination part 234 analyzes the smoothness of operation and the presence or absence of consideration for the surroundings from information such as the speed, acceleration, and angular velocity of the inverted pendulum type vehicle 100 in such a place, thereby evaluating the operation skill of the user U.

The third exemption condition is that the operation skill of the user U evaluated in the operation test of the inverted pendulum type vehicle 100 is at a predetermined level or above. In this case, it is assumed that at least a first test, a second test, and a third test are carried out in the operation test. The first test is a test for evaluating a skill for accelerating and decelerating the inverted pendulum type vehicle 100 while traveling straight. The second test is a test for evaluating a skill for turning and moving the inverted pendulum type vehicle 100. The third test is a test for evaluating a skill for stopping the inverted pendulum type vehicle 100. In this case, the exemption range determination part 234 determines that the third exemption condition is satisfied when the operation skill of the user U evaluated based on one or more of the test results of the first to third tests is at a predetermined level or above.

Then, when the third exemption condition is satisfied, the exemption range determination part 234 determines a fifth range preset for the third exemption condition as the exemption range of the user U. For example, if the third exemption condition is that “two or more of the test results of the first to third tests are passed,” the exemption range determination part 234 acquires the test data of the user U from the testing device 300, recognizes the pass/fail of each test, and determines whether two or more of the test results are passed. Then, when it is determined that two or more of the test results of the first to third tests are passed, the exemption range determination part 234 determines the fifth range as the exemption range of the user U.

When the test result is represented by a score, the exemption range determination part 234 calculates a score based on the results of the first to third tests, and when the score is greater than or equal to the threshold value, it may determine that the third exemption condition is satisfied. In this case, similar to the second exemption condition, if there are multiple threshold values, the fifth range may be provided for each threshold value. In general, it is natural that the higher the score, the larger the exemption range is given. In this case, the exemption range determination part 234 may determine the fifth range corresponding to the threshold value having the largest value among the threshold values smaller than the score of the user U as the exemption range of the user U.

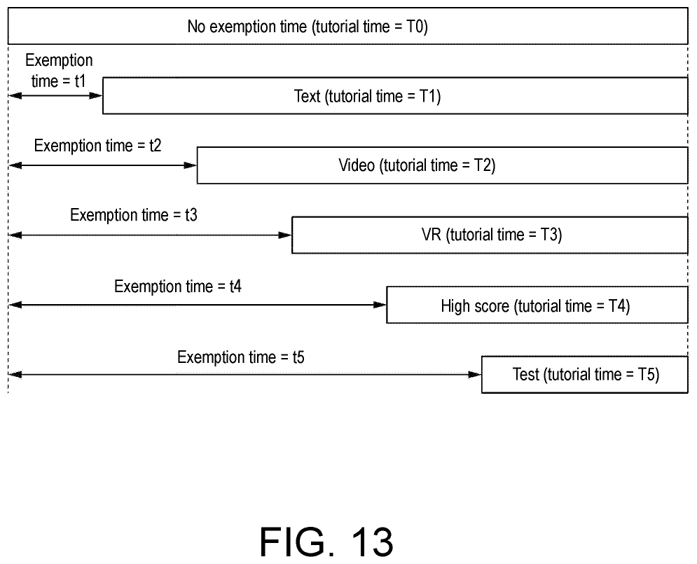

FIG. 13 is a diagram showing that in the vehicle rental system 1 of this embodiment, the pre-use tutorial is exempted within the range according to the experience of the user U regarding the operation of the inverted pendulum type vehicle 100. Here, for the sake of simple description, the exemption range is defined as the length of time during which the pre-use tutorial may be skipped (hereinafter referred to as “exemption time”). In addition, here, the exemption time is set to be longer in the order of the fifth range (exemption range based on the test result)>the fourth range (exemption range based on the usage history)>the third range (exemption range by browsing VR)>the second range (exemption range by browsing video)>the first range (exemption range by browsing text).

In FIG. 13, “no exemption time” represents the tutorial time in a situation where none of the exemption conditions are satisfied, that is, the required time T0 when all of the pre-use tutorial is attended. In addition, “text” represents the tutorial time when the user U has browsed the browsing data of the type “text” in advance. In this case, the user U may skip the pre-use tutorial by a first exemption time t1, and may finish the pre-use tutorial at the shortest time T1=T0−t1.

Further, in FIG. 13, “video” represents the tutorial time of the pre-use tutorial when the user U has browsed the browsing data of the type “video” in advance. In this case, the user U may skip the pre-use tutorial by a second exemption time t2, and may finish the pre-use tutorial at the shortest time T2=T0−t2.

Further, in FIG. 13, “VR” represents the tutorial time of the pre-use tutorial when the user U has browsed the browsing data of the type “VR” in advance. In this case, the user U may skip the pre-use tutorial by a third exemption time t3, and may finish the pre-use tutorial at the shortest time T3=T0−t3.

Further, in FIG. 13, “high score” represents the tutorial time of the pre-use tutorial when it is determined that the operation skill of the user U is at a predetermined level or above based on the usage history of the inverted pendulum type vehicle 100. In this case, the user U may skip the pre-use tutorial by a fourth exemption time t4, and may finish the pre-use tutorial at the shortest time T4=T0−t4.

Further, in FIG. 13, “test” represents the tutorial time of the pre-use tutorial when it is determined that the operation skill of the user U is at a predetermined level or above based on the result of the operation test of the inverted pendulum type vehicle 100. In this case, the user U may skip the pre-use tutorial by a fifth exemption time t5, and may finish the pre-use tutorial at the shortest time T5=T0−t5.

The vehicle rental system 1 of the embodiment configured in this way includes the exemption range determination part 234 that determines the exemption condition for the pre-use tutorial that the user U attends, and the tutorial management part 233 that manages attendance of the pre-use tutorial by the user U based on the determination result of the exemption condition, and the management device 200 is provided with the tutorial management part 233 configured to require that the user U attend all of the pre-use tutorial when the user U uses the inverted pendulum type vehicle 100 for the first time, and, when the user U has used the inverted pendulum type vehicle 100 in the past, to exempt the user U from attending a part or all of the pre-use tutorial when exemption conditions are satisfied. Further, by providing such a configuration, according to the vehicle rental system 1 of the embodiment, it is possible to reduce the human load required for explaining the operation method to the user in providing the service using the vehicle.

The embodiments described above may be expressed as follows.

A tutorial management device manages, for a user of a moving body, attendance of a pre-use tutorial on an operation method of the moving body conducted before use of the moving body, and is configured to include:

a storage device that stores a program; and

a hardware processor, and

by executing the program by the hardware processor, the tutorial management device performs:

determining an exemption range for the user who is exempted from attending a part or all of the pre-use tutorial based on a predetermined exemption condition; and

performing a tutorial management process that manages the attendance of the pre-use tutorial by the user based on the determined exemption range, and

in the tutorial management process, requiring all of the pre-use tutorial to be attended when the user uses the moving body for a first time, and exempting the user from attending the exemption range among the pre-use tutorial when the user has used the moving body in the past.

Although the modes for implementing the disclosure have been described above using the embodiments, the disclosure is not limited to these embodiments, and various modifications and replacements may be made without departing from the gist of the disclosure.

What is claimed is:

1. A tutorial management device that manages, for a user of a moving body, attendance of a pre-use tutorial on an operation method of the moving body conducted before use of the moving body, the tutorial management device comprising:
an exemption range determination part that determines an exemption range for the user who is exempted from attending a part or all of the pre-use tutorial based on a predetermined exemption condition; and
a tutorial management part that manages the attendance of the pre-use tutorial by the user based on the exemption range determined by the exemption range determination part,
wherein the tutorial management part requires all of the pre-use tutorial to be attended when the user uses the moving body for a first time, and exempts the user from attending the exemption range among the pre-use tutorial when the user has used the moving body in the past.

2. The tutorial management device according to claim 1, further comprising a browsing information management part that enables the user to browse browsing information related to the pre-use tutorial before attending the pre-use tutorial,
wherein the exemption condition is that the user has browsed the browsing information before attending the pre-use tutorial, and
the tutorial management part exempts the attendance of the pre-use tutorial for an exemption time according to a type of the browsing information browsed by the user.

3. The tutorial management device according to claim 2, wherein the tutorial management part exempts the attendance of the pre-use tutorial by a first exemption time when a type of the browsing information browsed by the user is text data, exempts the attendance of the pre-use tutorial by a second exemption time when the type of the browsing information browsed by the user is video data, and exempts the attendance of the pre-use tutorial by a third exemption time when the type of the browsing information browsed by the user is VR data.

4. The tutorial management device according to claim 3, wherein the exemption condition is that a score calculated based on a usage history of the moving body and indicating a level of a skill for the user to operate the moving body is greater than or equal to a predetermined threshold value, and
the tutorial management part exempts the attendance of the pre-use tutorial by a fourth exemption time when the exemption condition is satisfied.

5. The tutorial management device according to claim 4, wherein the score is calculated based on information of at least one of speed, acceleration, and angular velocity when the moving body moves at a predetermined place by an operation of the user.

6. The tutorial management device according to claim 4, wherein the exemption condition is that a result of an operation test related to an operation skill of the moving body which the user has taken before using the moving body is at a predetermined level or above, and
the tutorial management part exempts the attendance of the pre-use tutorial by a fifth exemption time when the exemption condition is satisfied.

7. The tutorial management device according to claim 5, wherein the exemption condition is that a result of an operation test related to an operation skill of the moving body which the user has taken before using the moving body is at a predetermined level or above, and
the tutorial management part exempts the attendance of the pre-use tutorial by a fifth exemption time when the exemption condition is satisfied.

8. The tutorial management device according to claim 6, wherein the operation test includes at least one of a first test to evaluate a skill of accelerating and decelerating while moving the moving body straight, a second test to evaluate a skill of turning and moving the moving body, and a third test to evaluate a skill of stopping the moving body.

9. The tutorial management device according to claim 7, wherein the operation test includes at least one of a first test to evaluate a skill of accelerating and decelerating while moving the moving body straight, a second test to evaluate a skill of turning and moving the moving body, and a third test to evaluate a skill of stopping the moving body.

10. The tutorial management device according to claim 6, wherein the first to fifth exemption times become longer in the order of the first exemption time, the second exemption time, the third exemption time, the fourth exemption time, and the fifth exemption time.

11. The tutorial management device according to claim 7, wherein the first to fifth exemption times become longer in the order of the first exemption time, the second exemption time, the third exemption time, the fourth exemption time, and the fifth exemption time.

12. The tutorial management device according to claim 8, wherein the first to fifth exemption times become longer in the order of the first exemption time, the second exemption time, the third exemption time, the fourth exemption time, and the fifth exemption time.

13. The tutorial management device according to claim 9, wherein the first to fifth exemption times become longer in the order of the first exemption time, the second exemption time, the third exemption time, the fourth exemption time, and the fifth exemption time.

14. The tutorial management device according to claim 1, wherein for the moving body, different decorations are determined according to the exemption time of the user.

15. The tutorial management device according to claim 2, wherein for the moving body, different decorations are determined according to the exemption time of the user.

16. The tutorial management device according to claim 3, wherein for the moving body, different decorations are determined according to the exemption time of the user.

17. The tutorial management device according to claim 4, wherein for the moving body, different decorations are determined according to the exemption time of the user.

18. The tutorial management device according to claim 5, wherein for the moving body, different decorations are determined according to the exemption time of the user.

19. A tutorial management method that manages, for a user of a moving body, attendance of a pre-use tutorial on an operation method of the moving body conducted before use of the moving body, in which a computer performs:
determining an exemption range for the user who is exempted from attending a part or all of the pre-use tutorial based on a predetermined exemption condition; and
performing a tutorial management process that manages the attendance of the pre-use tutorial by the user based on the determined exemption range, and
in the tutorial management process, requiring all of the pre-use tutorial to be attended when the user uses the moving body for a first time, and exempting the user from attending the exemption range among the pre-use tutorial when the user has used the moving body in the past.

20. A non-transient computer-readable recording medium, recording a program that manages, for a user of a moving body, attendance of a pre-use tutorial on an operation method of the moving body conducted before use of the moving body, the program causing a computer to perform:
determining an exemption range for the user who is exempted from attending a part or all of the pre-use tutorial based on a predetermined exemption condition; and
performing a tutorial management process that manages the attendance of the pre-use tutorial by the user based on the determined exemption range, and
in the tutorial management process, requiring all of the pre-use tutorial to be attended when the user uses the moving body for a first time, and exempting the user from attending the exemption range among the pre-use tutorial when the user has used the moving body in the past.
